(19) United States
(12) Patent Application Publication
(10) Pub. No.: US 2002/0159092 A1
(43) Pub. Date: Oct. 31, 2002

(54) Method and apparatus for embodying documents

(75) Inventors: Athena Christodoulou, Bristol (GB); Richard Taylor, Bristol (GB); Christopher Tofts, Bristol (GB)

Correspondence Address: HEWLETT-PACKARD COMPANY, Intellectual Property Administration, P.O. Box 272400, Fort Collins, CO, 80527-2400, US

(73) Assignee: HEWLETT-PACKARD COMPANY

(21) Appl. No.: 10/134,179

(22) Filed: Apr. 25, 2002

(30) Foreign Application Priority Data
Apr. 26, 2001 (GB) 0110203.7

(51) Int. Cl. G06F 15/00; B41B 1/00

(52) U.S. Cl. 358/1.15; 358/1.13

(57) ABSTRACT

An information technology network comprises a plurality of printers and at least one computing entity which serves as a print manager. Print jobs are distributed speculatively to a plurality of printers, which determine locally whether to proceed with the allocated job. Duplication of a job, by two or more printers is prevented by an appropriate communication protocol between printers.

The present invention relates to the conversion of source data into a document, such as for example, the printing of a document on paper or some other readable medium, from source data such as an electronic data file. A typical example of a source data file representing a document is an electronic data file, created using a word processing program, and which maybe embodied by printing onto paper, or display on a computer monitor, for example.

In this specification the term “document” is intended to be interpreted broadly, to encompass within its scope any assimilable manifestation of source data Thus a “document” may be embodied for visual assimilation (printed on paper, displayed on a monitor), aural (on audio tape) or tactile assimilation (e.g the printing of Braille), and while printing of a document may indicate one manner in which a document may be embodied (ie. on tangible “hard” media such as paper), it is not the only way of creating a document from a source data file. The process of converting source data into a document varies widely in dependence upon what is known as the “device implementation” of the source data, that is to say the genus of document to be created (e.g. visual, or tactile), and the specific parameters of the medium on which the document is to be embodied (e.g. in the case of printing, large paper, small paper, etc . . . , or even printing on some other medium such as for example a carpet).

In the case of printing source data onto paper (or some other printable medium), it is known to connect one or more elements of computing capability (e.g. Element which include both processing and storage capability in any form—e.g. shift registers—being classifiable as either a storage element, or part of a processor) to an electromechanical device adapted to deposit indicia (whether visible or not) onto paper, known in the art as a print engine, in order to produce a printed document. There are a number of different generea of print engine. One genus comprises a print-head supported on a carriage adapted to move laterally relative to an advancing page, so that marks may be deposited on any part of the page by a suitable combination of a lateral motion of the carriage and forward motion of the page. The majority of printers of this type deposit visible indicia on a page, and are colloquially known as an “inkjet” printer. A further genus, known as a “laserjet” printer has a rotating drum upon which ink (which term is intended to encompass toner and any other substance which may be used to create indicia, regardless of whether such indicia are visible in certain types of light) is deposited in a predetermined pattern by means of the use of electrostatic charge and a laser, subsequent contact between the surface of the drum and a page deposits the ink from the drum onto the page. In each case operation of the elements of the print engine is controlled by means of the computing elements to which they are connected, with the quality and speed of printing being dependent not only upon the print engine, but also on the operation and capability of the computing elements. Typically the various computing elements which are required in order to: (a) create a source data file; (b) transform the source data file into a set of instructions useable for controlling the print engine; and (c) control the print engine in accordance the aforementioned instructions, are distributed between different physical locations. Some are packaged with the print engine, others with a desktop computer, for example. In commercial vernacular the appliance which includes the print engine is known as a printer, regardless of how much or little computing is performed by ally computing elements which may be packaged with the print engine, and operations which are performed in order to produce a printed document from, for example, a document prepared using a word processing package are known as the “print pipeline”.

In contemporary information technology, printers and computers are frequently part of a network of, inter alia, one or more other printers and computers, all of which are either interconnectable or interconnected. Thus a user (whether a human user, or computing entity) working at a particular computer will frequently have a choice of a number of printers to use in order to perform a particular print job The selection the user makes may depend, for example, upon the size of the job, the desired quality of the job and the speed with which the job is required; in addition the user's choice may also be influenced by the availability of a particular printer and it's physical proximity.

The present invention relates to the appreciation that an information technology network which includes a plurality of printers has, intrinsically, a potential printing capacity which exceeds the currently achievable actual printing capacity when operated in accordance with existing methods.

In our co-pending European patent application, 01300824.8 we disclose implementations of network printing involving the use of a relatively sophisticated print management system, either distributed or centralised, having overall control of print operations within the network to the extent of instructing printers to rip source data without printing it, store ripped data, and send ripped data to a designated network location (usually another printer within the network). Such a print manager made use of processing and storage capability existing within current specification printers, but not currently used to its fill potential.

A first aspect of the present invention provides an alternative and substantially simpler approach to exploiting such processing and storage capability. Requests for performance of a job (i.e. a print process) are dispatched speculatively to a plurality of printers. Prevention of duplication is achieved largely by interaction between the network printers, rather than as a result of sophisticated central print management, as is the management of events following, e.g. interruption of a print job, e.g. by jobs of higher priority.

Accordingly a first aspect of the present invention provides a method of executing a print job comprising at least one print process, the method including the steps of: dispatching at least a job notice to a plurality of candidate printers; and upon acceptance of the job by one of the candidates, preventing any other candidate printer from executing the job.

The print job may well include plural print processes, such as ripping followed by activation of the print operations function (i.e. the physical process of placing indicia on a medium).

Acceptance of the job may be indicated by the completion of one of the processes which form apart of the job, for example ripping of a source data file. In this case, the first printer to complete the ripping process outputs a signal to this effect. Any other printer engaged in performing the job upon output of this acceptance signal receives the signal and ceases. Alternatively, acceptance of the job may be indicated prior to commencing any of the processes involved in executing the job, again by generation of an acceptance signal, which in this instance acts to prevent any other printer from commencing execution. The job notice may be either a job ticket providing data relating to the nature of the job, and optionally a pointer to the location of the source data, the source data on its own, or a combination of the two.

In one preferred embodiment, source data needed to perform the job is retained centrally upon issue of a job ticket, and acceptance of the job is followed by retrieval of the source data; execution of the job by other printers being prevented by the generation of an acceptance signal from the accepting printer.

In the event that a printer which has accepted the job is interrupted, for example by a job of higher priority, the interrupted printer may, in one embodiment, return a modified job notice, and the relatively simply steps elucidated briefly above may then be reiterated.

A further aspect of the present invention provides an information technology network including a plurality of printers, each of which having its own designated storage and processor, a print operations function including a print engine, and a network port via which communications with other printers of the network are sent and received, wherein the processor of each printer is adapted.

upon receipt of a request for performance of at least one print process via the network port, to determine whether, with regard to any print processes being undertaken or requested of the processor's printer, the printer has capacity available to perform the requested print process;

in event of an interruption to performance of a requested print process, to generate a modified request to reflect the extent to which the requested print process had been executed at the time of the interruption, and dispatch, via the network port, the modified request to another location within the network.

Typically the other location within the network will be a store of job notices, which is repeatedly scanned by a relatively simple program that sends unallocated job notices to candidate printers.

In one embodiment the processor is additionally adapted to store, within the designated storage, source data which has been modified by the performance of the print process prior to receiving an interruption,, or, where desired, to send such modified source data with the modified request to a predetermined location within the network.

Yet a further independent aspect of the present invention provides a printer comprising: a print operations function including a print engine and feed and finishing capability, a processor, at least one data storage medium, and at least one network port to enable connection of the printer to elements of an information technology network, wherein the processor is adapted to interupt performance of a print process on source data, create a modified job notice indicative of an extent to which the print process was completed on the source data when the interruption occurred, and to dispatch the modified job notice via the network port to a predetermined location within a network,

Preferably the processor is additionally adapted to store modified source data generated by the interrupted print process.

Embodiments of the present invention will now be described, by way of example, and with reference to the accompanying drawings, in which.

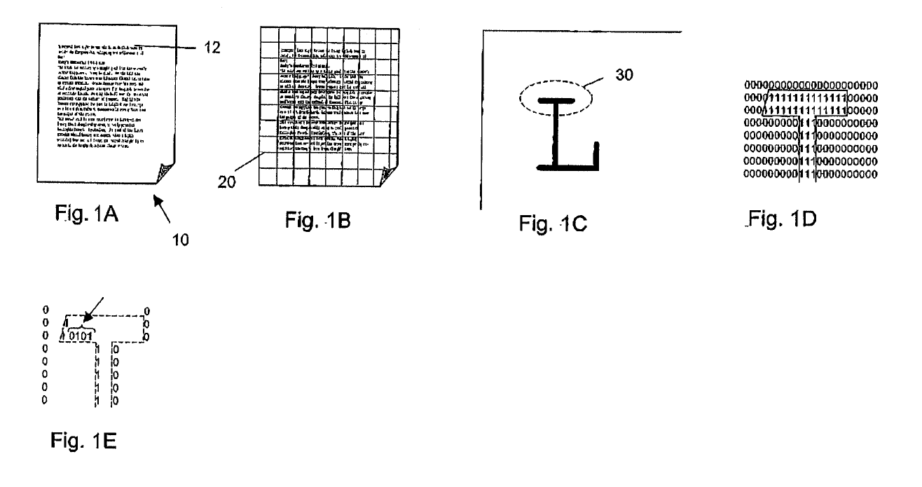

FIGS. 1A-E are schematic representations of operations forming part of the print pipeline;

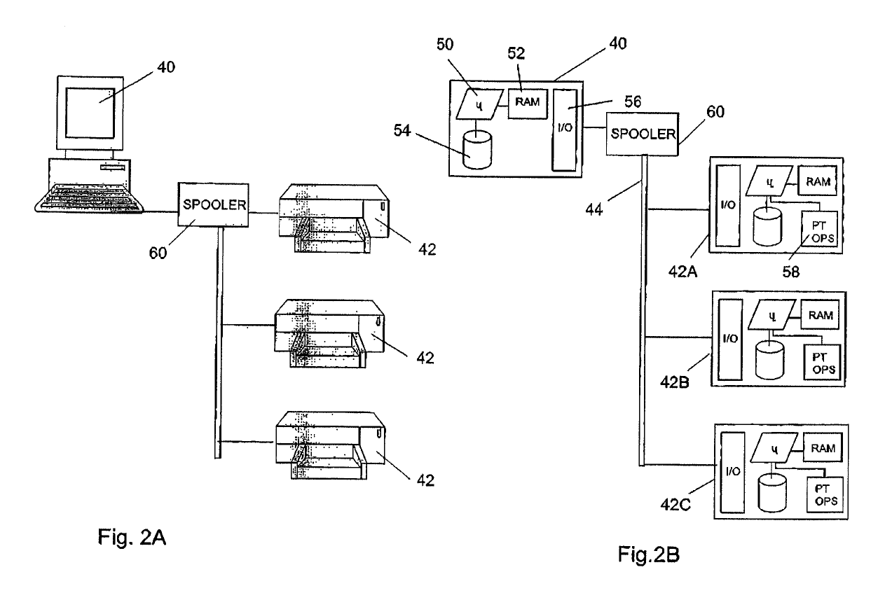

FIGS. 2A and B are schematic representations of an information technology network including a plurality of printers;

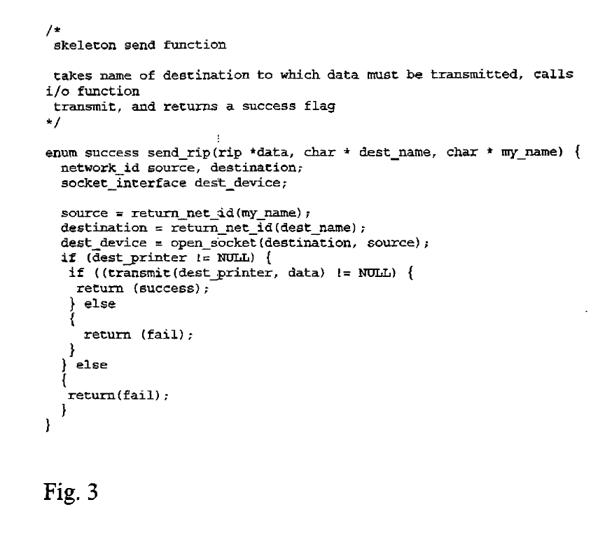

FIG. 3 is a program listing for an additional function executable within the network printers of FIGS. 2A and B;

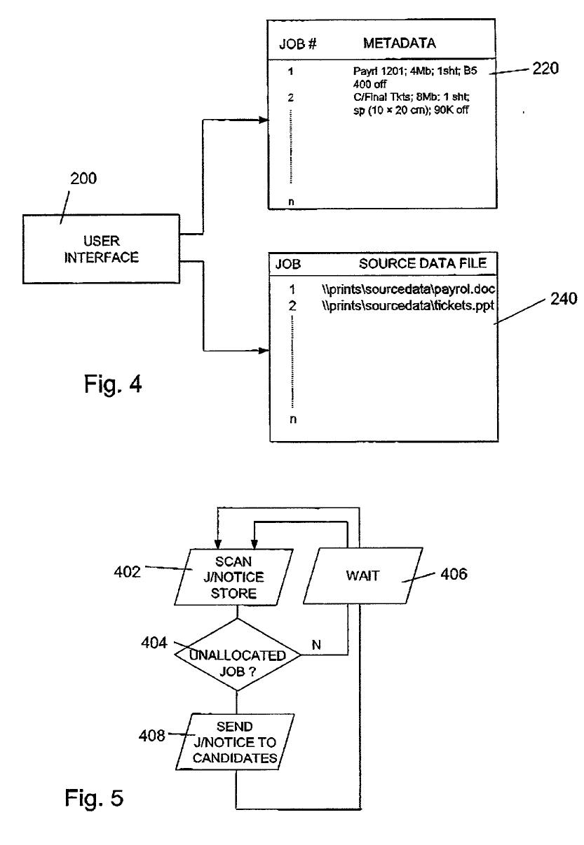

FIG. 4 is a schematic illustration o the logging and storage of printing jobs allocated in accordance with an embodiment of the present invention;

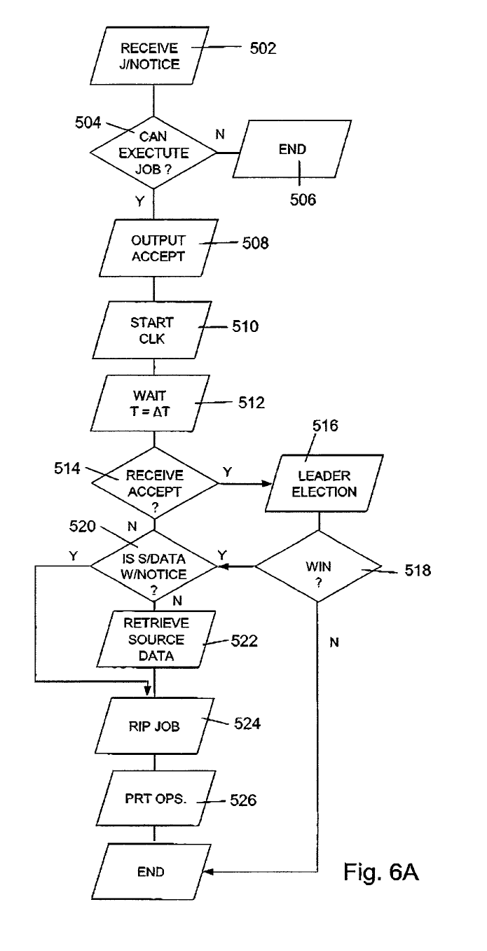

FIG. 5 is a flow chart illustrating operation of the identifying program executeable within the central computer; and

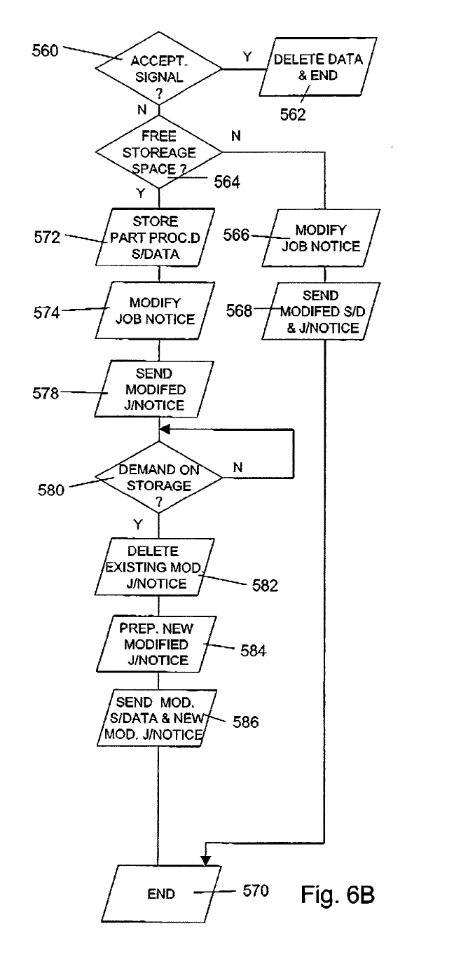

FIGS. 6A and B are flow charts illustrating operation of the print management program executeable within each of the network printers of FIGS. 2.

Referring now to FIGS. 1A-E, a document 10 contains lines of text 12, and both the text and its format on a page are stored with a source data file The source data file of the document will typically be created by reference to the document itself, the creator of the source file using the document which is created in real time on a computer screen from the source file as visual feedback for the creation of the source file. Typically, for source files created using word processing programs, the form of the source file will be particular to the word processing program that is being used to create it, although as is well known in the art there are features which are common to virtually all such programs, For example, in accordance with au ASCII standard, each letter of the alphabet is represented by a number (e.g. the letter “a” is represented by the number 56); however particular characters used to represent different formats for such letters differ from program to program.

The creation of a printed document from a source data file involves a number of operations which collectively are known as a “print pipeline”. The first operation within the print pipeline is to define a visual image of the document in a computer language called page control language (PCL for short). Referring now to FIG. 1B this involves defining a page in accordance with a predetermined size (typically determined by the creator of the source file), and dividing the page into a grid of boxes 20, each of which contains a relatively small amount of text. The provision of a representation of the document in PCL may be described in simple terms as breaking the page down into manageable chunks, themselves defined by the boxes 20 of the grid.

Referring now to FIGS. 1C and D, each of the individual grid boxes 20 is then subject to a process known in the art as ripping. Ripping is effectively a raster scan of a grid box 20, the result of which is that the text in the box is represented as an electronic digital array of a series of “1”s and “0”s. Thus the seriph of the capital “L” highlighted within the dashed ellipse 30 in FIG. 1C is seen represented by an array of “1”s against a background of “0”s as illustrated in FIG. 1D (an outline being shown for emphasis only). The resultant digital array (or “bitmap”) of numbers is then used directly to instruct the print engine where to deposit ink on a page, i.e. in the representation of FIG. 1D it is intended that ink is to be deposited by the print engine wherever there are “1”s, with the Spacing between adjacent bits typically being equal to the smallest indexing movement of the print engine which is repeatably achievable. An intrinsic characteristic of the ripping process is that because of the volume of processing operations required it is not possible to determine in advance the amount of time required to rip a given PCL file. Following ripping, the ripped data is stored, typically on one or more of the storage elements of the printer which is performing the printing. The ripped data is typically stored because, given the relatively large processing time, it is desirable to perform ripping of a document only once, and it frequently occurs that the print engine is not able to act upon the ripped data in real time, e.g. because it is busy, or simply because it is not able to operate sufficiently fast to keep up with the ripping process. However storage of ripped data creates a firer problem, because of the relatively large volume of data produced by the ripping process; the better the ripping process in respect of a given document the larger quantity of data that is produced, and as with the time required to complete a ripping operation, it is not possible to determine in advance the amount of data which will be produced by ripping process (there usually being an ephemeral requirement during the course of the ripping process for more disk space than simply the amount of disk space used to store the end result of the ripping process). It is thus necessary to compress the ripped data prior to storage, and an example of compressed ripped data is illustrated in FIG. 1E. The compression routine defines, for each row, the first bit of a section of the row where all subsequent bits are of the same type, and adjacent to that first bit, a binary number equal to the number of identical bits that follow in that row Thus for example, the first bit of an exemplified part of a row in FIG. 1E is a “1”, and is followed by the number “0101” (the number “10” in binary), indicating that 10 further bits of value “1” follow, thus constituting a saving of 6 bits stored (the ten bits that would have been stored in the absence of compression, less the four that are required in order to indicate the presence of these ten in uncompressed data).

In connection with the print pipeline described above, it should be noted that the form of source data is to an extent dependent upon perspective. Thus for example, from the perspective of preparing the PCL file, the source data will be the file created by the word processing program used to create the source data However, form the perspective of the ripping operation, the source data maybe regarded as the PCL file.

Referring now to FIGS. 2 A and B, the network of hardware elements for performing the operations thus far described includes a standard desktop PC 40, and a plurality of printers 42, all of which are interconnected via network links 44. The computer 40 and printers 42 include similar computing hardware elements, including in each case a processor 50, RAM 52, hard disc storage 54 and an input/output function (including LAN card, etc., as appropriate) 56, which will typically include a USB. In addition each of the printers 42 have the mechanical elements necessary for performing printing operations, i.e. a print engine, together with feed and finishing elements, all of which are represented schematically by the designation “Pt Ops”, and having the reference numeral 58. A network element known as a spooler 60, which has the function of acting as a data buffer between the computer and the printers is also provided, and comprises a storage disk and processor (not shown) Spoolers and their function are known per se and shall not be discussed per.

While existing printers have hardware which is similar from a functional point of view to that of computers, typically the hardware is configured, whether by application or system software, such that its capabilities are somewhat different to those of a computer. For example each of the printers will be equipped with what is, from a functional perspective, relatively standard application software, whose purpose is the performance of ripping, compression, and storage operations. In addition, each printer will also be provided with system software, typically stored on the hard disc storage 54, to enable the printers to receive and process relatively large volumes of data (eg. documents to be printed), and to send status information regarding the progress of a particular print job. A typical print operation involving the elements of the network described above operating in their usual (i.e. prior art) manner involves the dispatch to a particular printer of a source data file, which the printer in question then processes in the manner described in relation to FIGS. 1A-E above. During the course of this procedure, the printer is adapted to send back status information to the controlling computing entity regarding the number of pages processed and printed, or, in the event of a problem with the printing operation, an error message. Management of all such printing operations within the illustrated network is typically performed by a program running in computer 40, and which is frequently referred to as a print manager.

In accordance with one aspect of the present invention, it is provided that what may be termed the “latent” computing capability of each of the printers be made available to ameliorate bottlenecks in the print pipeline, but without the need for a relatively sophisticated print management program. Rather, in accordance with a first aspect of the present invention, the computer 40 runs a simple identifying program which identifies outstanding jobs, and sends them to suitable printers within the network, white the (relatively) more sophisticated print management tasks are performed by the network printers, each of which runs a print management program. In addition, each of the printers 42 is provided with auxiliary system software, which in the illustrated embodiment essentially amounts to a library function, known as a “SEND” function, a program listing for which is shown in FIG. 3. Execution of the SEND function causes the processor to dispatch designated data to a designated network location.

Referring now to FIG. 4, print jobs to be allocated are received in the present embodiment via a user interface 200, which could for example be simply the print manager in a graphical user interface for a desktop computer. The user interface maintains a log or store 220 of job tickets for outstanding jobs (i.e. jobs which have yet to be accepted and processed by a printer). The job tickets identify jobs and contain metadata relating to the nature of the job; in the present example the metadata includes the title of the job “Payrl 1201” for job No. 1 Dine a payroll notice for the month December of year 2001, the size of the source data file for the job (ere 4Mb), the number of sheets of paper on which the job must be printed (here 1), the size of the paper (here B5); and the number of copies (400) In addition, for each such job the user interface maintains a job store 240, which is a log of the source data files for given jobs, together with the file names and locations (given by virtue of path for the file), regardless of where the source data is stored within the network.

Referring now to FIG. 5, the short program, or “demon” which identifies outsanding jobs in the job ticket store 220 and dispatches them to printers runs continuously The demon “starts” at step 402 by scanning the job ticket store for outstanding jobs. At step 404 the demon determines whether there is al outstanding job; if there isn't then the demon waits at step 406 for a predetermined period of time, and then scans the job ticket store 220 once again. In the event there is an outstanding job, a job notice for the job is sent to candidate printers at step 408, following which the demon returns to the wait step 406 before once again scanning the job ticket store 220. As will be seen subsequently, when a printer accepts the job, the job ticket store is then modified to delete the job in question, so that only outstanding jobs remain within the job ticket store 220, which ensures that a job notice for a job which has not been accepted by a printer is continually re-allocated to candidate printers, and that a job notice for a job which has been accepted is not allocated twice unnecessarily. A “job” will typically be the printing of a document from a source data file, for example in the format produced by word-processing package, or a PCL file. However a job maybe merely a single step in the overall print process, such as ripping for example. A job notice is any message indicating that a job needs to be preformed, and in the present example, is simply a copy of the job ticket together with a pointer to the source data (thus reducing potentially unnecessary traffic across the network). How ever the job notice may also include the source data with the job ticket, or may even be, in appropriate cases, the source data on its own.

The step of sending the job ticket to candidate printers may be performed in a number of ways. In a first and most simplistic example the job ticket may be sent to every printer in the network, including those that do not have the inherent capability to perform job, having regard to, inter alia, the physical location of the printer, whether it is capable of colour printing for example, and its feed and finishing capabilities (e.g. whether it is able to produce collated bound copies). Alternatively, using data provided in the job request (this may be either implicitly provided in the source data, or explicitly provided as a form of metadata in the job request), the program identifies candidate printers within the network which are intrinsically capable of executing the job (data on such printers being available in a data table within computer 40), and dispatches a job ticket only to each of candidate network printer thus identified.

The program which runs within computer 40 is thus relatively simple, and does not perform any print management functions beyond identifying outstanding job tickets and dispatching them to printers, and in one embodiment identifying candidate printers on the basis of their inherent capability. The majority of the remaining processes to be performed and decisions to be taken occur under the auspices of the local print management programs running in the network printers 42. These programs are all substantially the same, but will not necessarily be operating identically at any given instant in time, since different conditions at different printers may cause the programs to follow different decision paths, while differing processing speeds of the printers may cause differing reaction speeds Referring now to FIG. 6A, the job notice, in this case a job ticket detailing the nature of the job, is received by a given network printer 42, e.g. in this example printer 42A at step 502, and at step 504 the management program running within the processor of the printer 42A determines whether the printer is able to execute the job. The steps involved in this determination depend upon the nature of the demon program running within computer 40. For example, in the event that the demon identifies candidate printers capable of performing the job, and dispatches job tickets only to those printers, step 504 simply involves determining whether, having regard to any other demands on its capability, the printer 42A is able to execute the job. However, in the event that the demon dispatches job tickets to every printer in the network the step 504 additionally involves assessing the nature of the job from the metadata on the job ticket, and determining whether printer 42A is inherently capable of performing such a job. In the event that the program determines that the printer is unable to execute the job (for whatever reason), the program simply ends at step 506, there being no need to return an error or some other “unsuccessful” message, since the demon is adapted automatically to re-dispatch the job ticket if it remains within the job ticket store. If the printer is able to execute the job, then at step 508 the program outputs an “ACCEPT” signal to all other printers within the network, at step 510 starts a clock, and at step 512 waits for a time ΔT, this being the maximum time required for the ACCEPT signal to reach any other printer within the network After waiting for the time period ΔT, the program then determines at step 514 whether an ACCEPT signal has been received from any other printer, this being possible since for the time period ΔT following emission of the ACCEPT signal by printer 42A, another printer may have also emitted such a signal prior to receiving he ACCEPT signal from printer 42A (these signals therefore, from a practical perspective, being emitted simultaneously) If such a signal has been received, then at step 516 there follows a process known in the art a “Leader Election”. In one example of Leader Election each of the printers which has both output and received an ACCEPT signal generates a random number, and the printer with the lowest number is the one that proceeds with the print job. At step 518 the program determines whether the printer 42A has won the Leader Election; if not then the process ends since there is nothing to print. If the printer 42A has won the Leader Election, or if it is determined at step 514 that no ACCEPT signals have been received, the program progresses to step 520 which determines whether the source data accompanies the job ticket; if it does not, then the source data is retrieved at step 522, and then ripped at step 524; if the source data accompanies the job, then the program skips the retrieval step 522 and proceeds directly to the rip step 524, following which the ripped data is sent to the Prt. Ops. at step 526.

An interruptive diagnosis program, not illustrated in FIG. 6A runs concurrently with the main program. This simply involves the repeated determination, of whether an INTERRUPT signal has been received during execution of the local print management program, in which event the local print management program of FIG. 6A skips from whatever step it is at to the Interrupt program of FIG. 6. Referring now to FIG. 6B, the interruption, routine initially determines, at step 560 whether the cause of the interruption is the receipt of au acceptance signal. If it is, then the program simply deletes all data relating to the job, and ends at step 562, since another printer has taken responsibility for the job. This scenario may apply it for example, under a slightly modified local print management program, the ACCEPT signal is not emitted by a printer until it has ripped the source data, in which case it is likely that more than one printer will be in the process of ripping data when such an ACCEPT signal is received (in His modification steps 508-518 would occur after ripping step 524) If no acceptance signal has been received and the interruption is therefore as a result, e.g. of a further demand on the printer, which demand has a higher priority than the currently executing job), then at step 564 the program determines whether there is sufficient free storage space to store the source data, as modified to whatever extent by any processing already performed If insufficient storage space is available, then the program modifies the job ticket at step 566 to reflect the processing that has been already performed on the source data (in order to avoid duplication of effort), and dispatches, using the SEND function, the modified job ticket back to the job ticket store 220, and the modified source data to the job store 240 at step 568, following which the program ends at step 570.

If at decision step 564 it is determined that sufficient storage space is available, then at step 572 the part processed job (i.e. the original source data as modified by the partial processing thus far undertaken) is stored within storage designated for that printer, and the job ticket is modified at step 574 to reflect firstly the new status of the job having regard to the processing thus far completed, and secondly to modify the pointer with the new storage address of the modified source data. At step 578 the modified job ticket is dispatched, using the SEND function, to job ticket store 220. Following dispatch of the modified ticket the program then determines, at step 580, whether the storage used to store the modified source data is required. If it is, then at step 582 the program the interrupt program deletes the modified job ticket from the job ticket store 220, prepares at step 584 anew modified job ticket which reflects the fact at the modified source data will now be stored in the job store 240 (since there is no longer sufficient space to store it locally at the printer 42A), and at step 586 the new modified job ticket is sent to the job ticket store 220, and the modified source data to the source data store 240 (in each case by means of the SEND function), whereupon the interrupt program ends.

In a simplified version of the interrupt routine, the job is simply interrupted, and upon interruption, deleted from any storage of the printer, and the original job ticket returned to the store 220.

In a firer modification, itself providing an independent aspect of the present invention, interruption of a job being executed within a printer is prevented by sending any data (e.g. job ticket, source data, and/or any other data sent to the printer pursuant to the execution of the job) received during processing of a back to the spooler 60 for storage, thus providing a further measure against wasted processing effort.

As mentioned previously, printers include a relatively large amount of processing and storage capability which might more ordinarily be associated with computers, and in contemporary commercial terms the distinction between printer and computer turns primarily upon which of the two includes the print operations functionality. It may be the case that a printer in a network possesses storage and processing capability which is remotely located in geographical (both in the IT network and the more ordinary sense) terms, but which is specifically allocated to that printer (which does not exclude co-allocation to another printer) for the purpose of ripping, compressing and storing data Indeed it is sometimes the case that the ripping for a particular printer takes place inside the computer which is being used to dispatch source data to the printer in question for printing. It is thus on occasions difficult to establish whether a particular block of computing functionality is, in functional terms, part of a particular printer. One relatively straightforward (though not exhaustive) test is to view the issue from the perspective of the print manager which is controlling the network printing operation. Thus, for example, if a particular element or elements of computing capability appear to the print manager to be operating on behalf of the print operations function of a particular printer, then they should be considered for the purposes of the present invention to comprise part of that printer, even though, for example, they may well be physically located in the same computer which is operating the print manager.

Reference has been made, in order to exemplify the methods and apparatus' of the present invention to the creation of source data files using word processing programs. It is to be emphasized that source data files for printing may come from many sources and have many forms, including without limitation, automatic utility bill generating software, for example, to provide many different types of “document”.

1. A method of executing a print job comprising at least one pint process, the method including the steps of: dispatching at least a job notice to a plurality of candidate printers; and upon acceptance of the job by one of the candidates, preventing any other candidate printer from executing the job.

2. A method according to claim wherein the print job includes more than one print process, and acceptance of the job is indicated by a candidate printer upon completion of a predetermined print process on source data for the job.

3. A method according to claim 2 wherein acceptance is indicated by generation of a signal.

4. A method according to claim 3 wherein the predetermined print process is ripping of the source data.

5. A method according to claim 1, wherein acceptance of the job is indicated by a candidate printer prior to commencement of the job.

6. A method according to claim 1 wherein a plurality of candidate printer unit simultaneous acceptance signals indicating acceptance of the job.

7. A method according to claim 6 further comprising the step of selecting a single candidate of the plurality of accepting printers.

8. A method according to claim 7 wherein the selection process is leader election.

9. A method according to claim 1 wherein the job notice is a job ticket and pointer to the source data.

10. A method according to claim 1 wherein the job notice is a job ticket and the source data.

11. A method according to claim 1 wherein the job notice is the source data.

12. A method according to claim 1 further comprising the step of identifying candidate printers inherently capable of performing the job before dispatch of the job notice.

13. A method according to claim 1 further comprising the step, performed by each candidate printer upon receipt of the job notice, of determining whether it is capable of performing the job.

14. A method according to claim 1 further comprising the step of repeatedly scanning a store of job notices and dispatching any unallocated job notices to candidate printers.

15. A method according to claim 14 further comprising the steps, subsequent to acceptance of the job by a given candidate printer, of: interrupting execution of the job by the given printer with a subsequent job of higher priority; modifying the job notice to reflect the extent to which the job had been executed at the time of interruption; modifying the source data to include any data generated prior to interruption of the job; and sending at least the modified job notice specifying a modified job to the store.

16. A method according to claim 15 further comprising the steps, subsequent to acceptance of the modified job by another candidate printer, of preventing any other candidate printers from executing the job.

17. A method according to claim 14 further comprising the steps, subsequent to acceptance of the job by a given candidate printer, of: interrupting execution of the job by the given printer with a subsequent job of higher priority; deleting the source data from storage of the given candidate printer; and returning an unmodified job notice to the store.

18. A method of executing a print job including at least one print process in an information technology network comprising a plurality of printers, each having its own designated storage and processing capacity, the method comprising the steps of:
dispatching, via the network, at least a job ticket to each of a plurality of candidate printers; and
upon acceptance of the job by one of the candidate printers, preventing any other candidate printer from executing the job.

19. A method according to claim 18 wherein job notices are retained in a store within the network, and the method further comprises the steps of repeatedly scanning the store and dispatching any unallocated job notices to candidate printers.

20. A method according to claim 19 further comprising the steps, subsequent to acceptance of the job by a given candidate printer of: interrupting execution of the job by the given printer with a subsequent job of higher priority; modifying the job notice to reflect the extent to which the job had been executed at the time of interruption; modifying the source data to include any data generated prior to interruption of the job; and sending at least the modified job notice to the store.

21. A method according to claim 20 wherein the modified source data is stored by the given candidate printer, and the modified job notice includes a pointer to the address within the network of the modified source data.

22. A method according to claim 20 wherein the modified source data is returned by the given candidate printer to an address within the network at which the source data was stored upon initial allocation of the job.

23. An information technology network including a plurality of printers, each having its own designated storage and processor, a print operations function including a print engine, and a network port via which communications with other printers of the network are sent and received, wherein the processor of each printer is adapted:
upon receipt of a request for performance of at least one print process via the network port, to determine whether, with regard to any print processes being undertaken or requested of the processor's printer, the printer has capacity available to perform the requested print process;
in event of au interruption to performance of a requested print process, to generate a modified request to reflect the extent to which the requested print process had been executed at the time of the interruption, and dispatch, via the network port, the modified request to another location within the network.

24. A network according to claim 23 wherein the processor is additionally adapted to store modified source data for the requested print process on the designated storage of the processor's printer, the modified source data including data generated during performance of the requested print process and prior to the interruption of the requested print process.

25. A network according to claim 23 wherein the processor is additionally adapted to send, together with the modified request, modified source data including data generated during performance of the requested print process and prior to the interruption of the requested print process.

26. A network according to claim 23 wherein the processor is adapted to send the modified print process request to a store of print processes awaiting performance.

27. A printer comprising: a print operations function including a print engine and feed and finishing capability, a processor, at least one data storage medium, and at least one network port to enable connection of the printer to elements of an information technology network, wherein the processor is adapted to interrupt performance of a print process on source data, create a modified job notice indicative of an extent to which the print process was completed on the source data when the interruption occurred, and to dispatch the modified job notice via the network port to a predetermined location within a network.

28. A printer according to claim 27 wherein the processor is additionally adapted to store modified source data generated by the interrupted print process.
